(19) United States
(12) Patent Application Publication
(10) Pub. No.: US 2024/0369739 A1
(43) Pub. Date: Nov. 7, 2024

(54) ULTRAVIOLET FILTERING PHOTONIC MATERIALS

(71) Applicant: President and Fellows of Harvard College, Cambridge, MA (US)

(72) Inventors: MING XIAO, Cambridge, MA (US); Vinothan N. MANOHARAN, Cambridge, MA (US); Jennifer A. MCGUIRE, Cambridge, MA (US); Anna B. STEPHENSON, Cambridge, MA (US); Victoria HWANG, San Jose, CA (US); Audrey von RAESFELD, Cambridge, MA (US)

(73) Assignee: President and Fellows of Harvard College, Cambridge, MA (US)

(21) Appl. No.: 18/683,178

(22) PCT Filed: Aug. 12, 2022
(86) PCT No.: PCT/US2022/074927

§ 371 Date: Feb. 12, 2024

Related U.S. Application Data
(60) Provisional application No. 63/232,478, filed on Aug. 12, 2021.

(51) Int. Cl. G02B 1/00; G02B 5/20

(52) U.S. Cl. CPC G02B 1/005; G02B 5/208

(57) ABSTRACT

Disclosed herein is a photonic material for reducing transmission of ultraviolet light. The photonic material has spherical scatterers in a matrix material. The spherical scatterers have an amorphous arrangement in the matrix material and are configured to scatter ultraviolet light traveling in the matrix material. The amorphous arrangement of the spherical scatterers causes multiple scattering of the ultraviolet light. Absorbing material is disposed within the matrix material or the spherical scatterers and absorbs the ultraviolet light traveling in the matrix material.

### STATEMENT OF GOVERNMENT RIGHTS

This invention was made with government support under 2011754 and 1420570 awarded by National Science Foundation (NSF). The government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

All patents, patent applications and publications cited herein are hereby incorporated by reference in their entirety in order to more fully describe the state of the art as known to those skilled therein as of the date of the invention described herein.

### FIELD OF THE INVENTION

The present application relates to ultraviolet (“UV”) filtering materials. More particularly, the application relates to UV filtering photonic materials.

### BACKGROUND

UV radiation, electromagnetic wavelengths between 10 to 400 nm, is harmful to human health, with health effects ranging from skin redness to skin cancer. In addition, UV can cause degradation or facilitated aging in plastics. Most UV filtering or protection approaches involve organic dyes that can photodegrade or minerals that scatter visible light and can cause a white appearance. In addition, broadband UV protection over both UVA (320-400 nm) and UVB (290-320 nm) requires combination of dyes that absorb different wavelengths.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a schematic of the optical properties of sunscreens according to certain embodiments;

FIG. 2 is a schematic of the reflectance and absorption (i.e., 1—transmittance), according to certain embodiments;

FIG. 3 view (A) is a schematic of parameters to form a UV filtering photonic material according to certain embodiments, and view (B) is a model of the trajectory of light packets through a UV filtering photonic material according to certain embodiments;

FIG. 4 view (A) is a schematic of a direct structure and an inverse structure according to certain embodiments, view (B) is a graph of the reflectance of an inverse structure and a direct structure according to certain embodiments, and (C) is a graph of the transmittance of an inverse structure and a direct structure according to certain embodiments;

FIG. 5 is a graphical representation of the reflectance of a UV filtering photonic material using an inverse matrix with different air void radii (view A) and different volume fractions (view B), according to certain embodiments;

FIG. 6 is a graphical representation of the reflectance of an inverse PLA structure according to certain embodiments;

FIG. 7 is a graphical representation showing the effect of polydispersity on the reflectance of inverse PLA according to certain embodiments;

FIG. 8 is a graphical representation of the refractive index (view “a”) and the reflectance (view “b”) as a function of wavelength for various UV filtering materials according to certain embodiments;

FIG. 9 is a graphical representation of the transmittance of UV filtering materials according to certain embodiments incorporating melanin as an absorber;

FIG. 10 is a graphical representation of the transmittance of UV filtering materials according to certain embodiments incorporating TiO₂ as an absorber;

FIG. 11 is a graphical representation of the transmittance of UV filtering materials according to certain embodiments incorporating ZnO as an absorber;

FIG. 12 is an illustration of three configurations of an absorber (left wide) and respective transmittance at 350 nm, according to certain embodiments;

FIG. 13 is a schematic of different packing of spherical scatterers (left) and a comparison of the respective structure factor (right) according to certain embodiments;

FIG. 14 is a graphical representation of the reflectance (left) and transmittance (right) of spherical scatterers according to certain embodiments;

FIG. 15 is a comparison of the transmittance of UV blocking materials according to certain embodiments;

FIG. 16 is a representation of the amount of ZnO (by volume) required to be added to a photonic sunscreen to achieve particular sun protection factors (SPF);

FIG. 17 is a representation of the reflectance of three illustrative skin tones according to certain embodiments;

FIG. 18 is a schematic of a photonic sunscreen on skin, showing how reflectance can be calculated according to certain embodiments;

FIG. 19 is a graphical comparison of the reflectance of photonic sunscreens on different skin tones to that of commercial sunscreens, calculated using the model described in FIG. 18 and skin reflectance data shown in FIG. 16, according to certain embodiments;

FIG. 20 is a graphical representation of the transmittance (view (a)), reflectance (view (b)), and absorptance (view (c)) of inverse structures of silica spheres in an acrylate mixture according to certain embodiments

FIG. 21 is an illustration of photonic balls according to certain embodiments;

FIGS. 22A-22B are scanning electron microscopy images of an inverse photonic

glass made of a poly (vinyl alcohol) matrix surrounding air pores, according to certain embodiments;

FIG. 23 is a scanning electron microscopy image of an inverse photonic glass made of a fused silica matrix surrounding air pores, according to certain embodiments.

### DETAILED DESCRIPTION

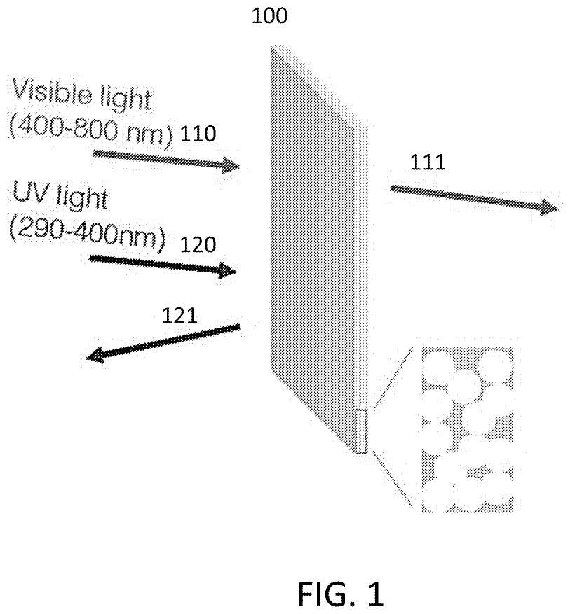

Here, we propose a new way of broadband UV filtering using photonic materials that are made of spherical nanoparticles or air voids with sizes of 100-300 nm. Specifically, we design systems for application in sunscreens, where we aim to block more than 90% ultraviolet (UV) irradiation with wavelengths from 290-400 nm while maintaining visible transparency (FIG. 1). Because the optical properties of photonic materials mainly depend on the nanostructures, rather than the chemistry of the materials, this approach has the flexibility to be used with sustainable materials.

Disclosed herein is a method of UV filtering that uses photonic structures. As described herein, the photonic structure causes multiple scattering (multiply scatters) and reflects the UV light. In certain embodiments, an absorbing material can be added to further decrease UV transmission. However, in certain embodiments, the absorbing material need only be introduced in small amounts.

In certain embodiments, the UV filtering photonic material is made of air voids in a matrix that are packed in a disordered way, such that they are packed amorphously (e.g., not crystalline) but such that there is a short-range correlation between the positions of the voids (e.g., they are not completely random). In certain embodiments, the air pores embedded in a UV-transparent polymer matrix can block up to 75% of both UVA and UVB light.

In certain embodiments, the UV filtering photonic material is used for sunscreen applications. The UV blocking efficiency can be boosted, for example to specific sun protection factor (SPF) values, by adding a small amount of scattering nanoparticles such as TiO₂ and/or ZnO. The UV filtering photonic sunscreen takes advantage of multiple scattering (e.g., light scattering more than once in the sample before exiting) to enhance blocking of UV light while also maintaining transparency in the visible spectrum, which ensures that the sunscreen minimally affects the appearance of the skin when it is applied. According to certain embodiments, the UV filtering photonic sunscreen blocks more than 90% UV irradiation with wavelengths from 290-400 nm while maintaining visible sufficient transparency in the visible spectrum.

In certain embodiments, the porous structures of the UV filtering photonic material can be made by biodegradable polymers. Such biodegradable polymers can enhance the sustainability of sunscreens and decrease their environmental impact.

FIG. 1 shows a schematic of the optical properties of UV filtering photonic materials according to certain embodiments. The UV filtering photonic material 100 is a nanostructure that reflects UV light and is transparent to visible light. For example, visible light in the range of 400-800 nm is transmitted from the left side of the UV filtering photonic material 100 (arrow 110) to the right side of the UV filtering photonic material 100 (arrow 111), visible light in the range of 290-400 nm from the left side of the UV filtering photonic material 100 (arrow 120) to the right side of the UV filtering photonic material 100 (arrow 111) is not transmitted through UV filtering photonic material 100 but is instead reflected (arrow 121).

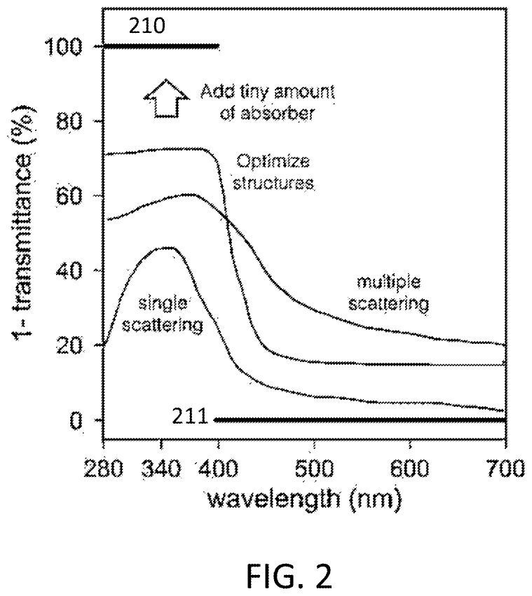

In certain embodiments, the UV filtering photonic materials takes advantage of structural colors and multiple optical effects to produce structures that minimize UV transmittance while maximizing the visible transmittance. An ideal UV filtering material transmits 0% of UV light and 100% of visible light. The ideal UV filtering material results in the skin (for sunscreen application embodiments), or substrate (for other UV-filtering application embodiments) being maximally protected while its color remains unaltered by the application of the material. Because transmission is the sum of reflection and absorption, 0% UV transmission corresponds to 100% UV being reflected or absorbed, and 100% visible transmission corresponds to 0% visible light being reflected or absorbed. The percentage of light reflected and absorbed can be quantified as (1—transmittance). FIG. 2 shows the amount of light reflected and absorbed (%) as a function of wavelength (nm). For example, the black straight lines 210 and 211 together show the amount of light reflected and absorbed for an ideal UV filtering material.

Embodiments disclosed herein perform closer to the ideal UV filtering material than other UV filtering materials. One such other UV filtering material is made of colloidal particles embedded in a matrix that has a similar refractive index to that of the particles. Because of this low refractive-index contrast, light scatters weakly and the UV reflectivity is low, for example, not high enough to meet sunscreen requirements. The reflection and absorption of such a UV filtering material is shown as the “single scattering” line in FIG. 2. In contrast, certain embodiments of the instant application use strongly scattering materials in which light scatters more than once (“multiple scattering”) to achieve broader and higher UV reflectance.

While multiple scattering decreases the UV transparency as the strength of scattering increases, the visible transparency can also decrease, leading to coatings with undesirable opacity in the visible range. For example, increasing UV reflectance by increasing the refractive-index difference between the particles and matrix can compromise visible transparency. In certain embodiments, this tradeoff between UV reflectance and visible transparency is broken by using materials in which the particles or voids have a lower refractive index than the matrix. Optimizing the structure sharps the transition in reflectance between the UV and visible regimes: these optimized structures allow the UV light to be preferentially reflected and the visible light to be preferentially transmitted. These structures are optimized, for example, by tuning the sizes of the nanoparticles or pores and their volume fraction in the matrix until the transmittance and reflectance meet the desired UV blocking and visible transparency. In certain embodiments, a small amount of absorbing nanoparticles can be added to increase UV blocking. The multiple scattering approach enhances the blocking of UV light by the nanoparticles-in other words, multiple scattering is synergistic with nanoparticle absorption.

As described above, FIG. 2 is a schematic plot to show how multiple optical effects are used to make UV-reflective and transparent photonic materials for uses like sunscreens. The two straight lines represents an ideal spectrum where the UV transmittance is zero and visible transmittance is 100%. The lowest curve represents a typical spectrum of a weakly scattering system where single scattering dominates. The curve labeled “multiple scattering” represents a similar system, in which the particles are embedded in air or another low index matrix, resulting in multiple scattering. In this situation the UV reflectance is increased but the visible transmittance is reduced. The curve labeled “optimized structures” represents an optimized multiple scattering system consisting of an inverse structure: air pores embedded in a matrix, according to certain embodiments. The pore size and volume fraction are chosen so that the system has high UV blocking and high visible transparency, and a sharp transition between these two regimes. The “optimized structures” curve more closely approximates the ideal system and is therefore a better UV filtering material.

### Multiple Scattering Model

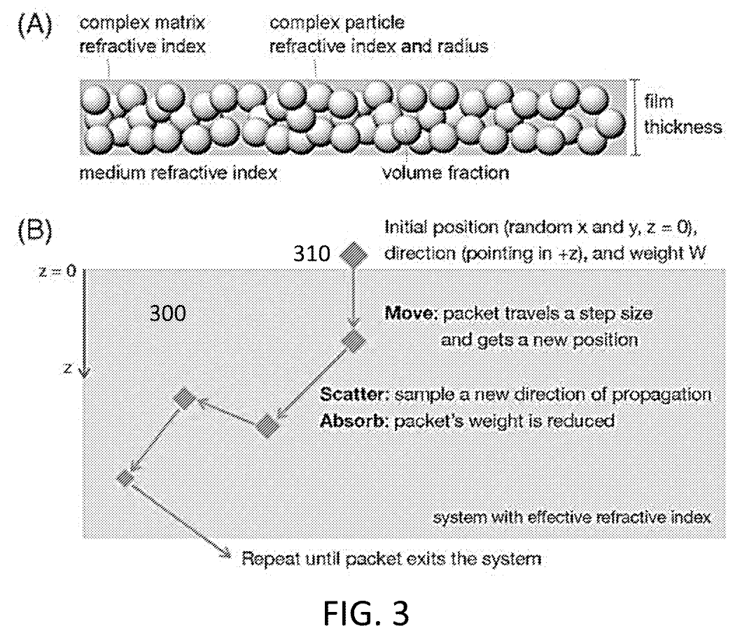

As described below, in certain embodiments, a multiple scattering model can be used to calculate the optical properties of films containing nanoparticles or pores 100-300 nm in diameter. The model is based on a Monte Carlo simulation of the trajectories of photons inside a structurally colored sample. In certain embodiments, the system is a film containing a disordered packing of spherical scatterers (which can be made of solid particles or air) in a matrix. The model takes as input parameters the complex refractive index and the radius of the spherical scatterers, the complex refractive index of the matrix, the volume fraction of the scatterers in the sample, and the thickness of the film. FIG. 3 view (A) shows a schematic of a such a structurally colored film along with illustrations of the aforementioned respective inputs to the mode, according to certain embodiments. When the scatterers are polydisperse as in certain embodiments, the polydispersity index is also an input, and when the film is made of a mixture of two scatterers of different sizes as in certain embodiments, the mean radius of the second scatterer and its concentration is also an input. In certain embodiments, the incident light is collimated light normal to the sample for illustrative purposes.

FIG. 3 view (B) illustrates how the UV filtering photonic material 300 filters UV light, according to certain embodiments, using a Monte-Carlo-based multiple scattering model. Photon packets 310 have initial positions, directions, and weights. The positions are the (x, y, z)-coordinates in the sample's reference frame, and the packets start at z=0 and are randomly distributed along x and y. The directions are the directions of propagation after each scattering event and are initially in +z if the sample surface is smooth. The weights account for absorption in the sample, which comes from a non-zero imaginary refractive index of any of the sample materials (such as TiO₂ or ZnO), according to certain embodiments. For example, each photon packet starts with an initial weight of 1. As photon packets travel through the sample, if there is absorption in the sample, the packets are gradually absorbed according to the Beer-Lambert law, and their weights decrease accordingly. The imaginary component of the refractive index determined the absorption coefficient, which determines the rate at which the photon weight decreases as it travels through the sample. In addition, the imaginary refractive index also affects the Mie solutions, which are calculated as part of the model and are used in calculating the step size distribution and the phase function.

Initially, as demonstrated in FIG. 3 view (B), photon packets are launched into the system by taking a step. Then they scatter and adopt a new direction of propagation, which is randomly sampled from the phase function calculated from a single-scattering model as described below. At this point, the packet weights are updated if there is absorption in the system. For example, in certain embodiments absorption occurs if there is any material with a non-zero imaginary refractive index in the matrix. In certain embodiments, the matrix material, an added absorber, or a combination of the two effectuate(s) the absorption. The packets then take another step, and this process is repeated until the packets exit the sample. After simulating the trajectories of thousands of packets, the reflection and transmittance spectra are computed by adding the total weights of reflected and transmitted packets at different wavelengths.

In certain embodiments, the step sizes and the directions of propagation are randomly sampled from distributions, capturing the stochastic nature of multiple scattering. The step size distribution is based on Beer's law, and its mean is the scattering length:

$$p ( step ) = \frac{1}{{l}_{s c a}} {e}^{- \frac{step}{{l}_{sca}}} , {l}_{sca} = \frac{1}{ρ {C}_{sca}^{sample}} \qquad ( 1 )$$

where p(step) is the probability of a step size, l_{sca} is the scattering length, ρ is the number density of scatterers, and C_{sca}^{sample} is the scattering cross-section of the sample calculated with an adapted version of a single scattering model that uses Bruggeman's approximation for the effective refractive index of the sample. The Bruggeman effective medium index is calculated from the following equation:

$$\begin{matrix}{\sum }_{j = 1}^{N} {f}_{j} \frac{{n}_{j}^{2} - {n}_{B G}^{2}}{{n}_{j}^{2} + 2 {n}_{B G}^{2}} = 0 , & where {\sum }_{j = 1}^{N} {f}_{j} = 1 ,\end{matrix} \qquad ( 2 )$$

where N is the number of components in the sample, fⱼ and nⱼ are the volume fraction and complex index of component j, and n_{BG} is the complex Bruggeman effective index of the sample.

The phase function describes the probability that light is scattered in a certain direction:

$$p ( θ ) = \frac{{dC}_{sca}^{sample}}{d Ω} \frac{1}{{C}_{sca}^{sample}} \qquad ( 3 )$$

where p(θ) is the phase function at scattering angle θ and

$$\frac{d {C}_{sca}^{sample}}{d Ω}$$

is the differential scattering cross section of the sample calculated with the single-scattering model, which takes into account Mie theory as well as constructive interference from short-range correlations between particles.

### UV Filtering Materials

Described herein is a parameter space to tailor the performance of UV reflecting materials, according to certain embodiments. In certain embodiments, the performance is tailored for use as sunscreens. In certain embodiments, sunscreens can only allow certain materials that are safe for use on humans. Refractive indices of safe and/or environmentally friendly materials are used in certain embodiments. According to certain embodiments, poly(lactic acid), or PLA, a biodegradable polymer that has negligible absorption at the UV and visible wavelengths is used. However, this application is not limited to use of PLA, as other polymers will perform similarly. In certain embodiments, the matrix material can include biodegradable or bioderived polymers that are transparent to visible light (e.g., do not absorb much visible light), for example, the biopolymers cellulose and silk. In certain embodiments, the matrix material is simply a material that is transparent to visible light, including certain polymers, liquids, oxides (such as silica or zirconia), or other such materials.

The sun protection factor (SPF) is a measure of how much UV radiation is required to produce sunburn on skin covered with sunscreen compared to without sunscreen. As described herein, SPF is related to both UV transmittance and UV damage on skin at different wavelengths. The standard is based on 20 mg of sunscreen on an area of 1 cm², which implies a constraint on sample thickness in examples described herein.

### Inverse Structures and Direct Structures

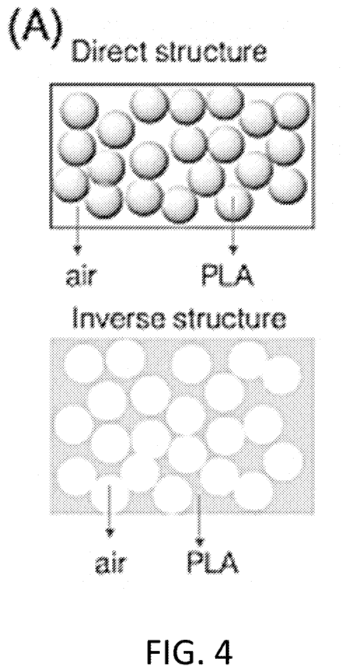

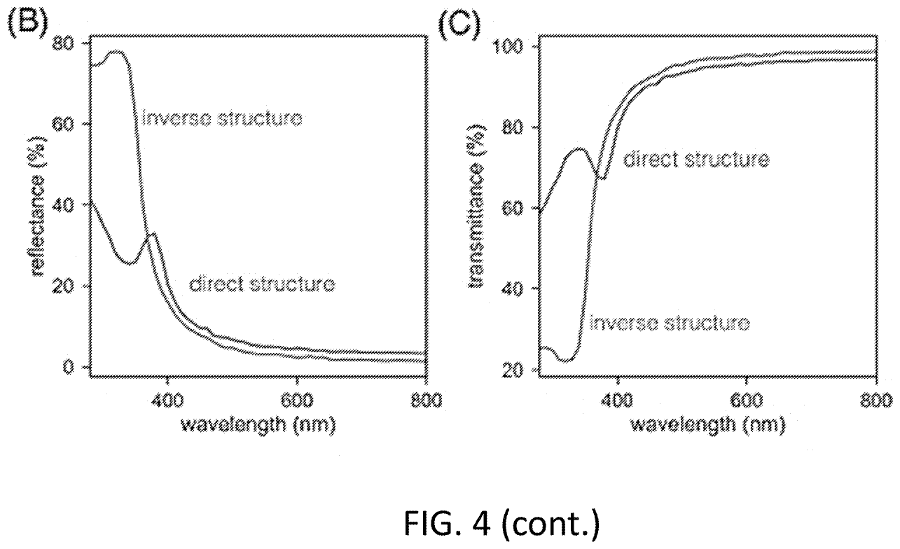

According to certain embodiments, the UV filtering materials are made of one of inverse structures or direct structures. FIG. 4 view (A) illustrates direct structures on top and inverse structures on the bottom. Inverse structures are those where the spherical inclusions have a smaller refractive index than the matrix material. Direct structures are those where the spherical inclusions have a larger refractive index than the matrix material.

The UV blocking efficiency and visible transparency of direct and inverse structures can be compared. In certain embodiments, the direct structure is made of PLA nanoparticles in a matrix of air, and in certain embodiments the inverse structure is made of air voids in a matrix of PLA, as shown in FIG. 4 view (A). In certain embodiments, the structure has a volume fraction of 0.64. Other embodiments can use different volume fractions. Different volume fractions affect the degree of short-range correlations as described above, and the width of the reflection peak. A smaller volume fraction corresponds to a broader but weaker reflection peak. In certain embodiments, any volume fraction up to 0.64 can be used. In certain embodiments, to be consistent with the SPF test standard, both the inverse structure and the direct structure have a mass of 20 mg per cm², which corresponds to a thickness of 25 μm for the direct structure and 44 μm for the inverse structure. Other embodiments can use different thicknesses, such as less than 1 μm, less than 10 μm, less than 50 μm, less than 100 μm, less than 200 μm, less than 500 μm, or less than 1 mm. In certain embodiments, for example certain sunscreen embodiments, the thickness is constrained by the SPF standard.

FIG. 4 views (B) and (C) show the reflectance and transmittance, respectively, of (1) a direct structure with air voids with volume fraction 64% and radius 90 nm, and thickness 25 μm, and (2) an inverse structure with air voids with volume fraction 64% and radius 90 nm, and thickness 44 μm. The inverse structure reflects much more in the UV regime than the direct structure, and the UV reflectance peak covers the UVB regime completely and the UVA regime partially. By comparison, the direct structure has a UV reflectance that is about a factor of 2 smaller, and it has a higher visible reflectance. Thus the inverse structure performs better (has higher UV reflectance and higher visible transparency) in both the UV and the visible.

### Inverse Structures with High Reflectance of UV Light

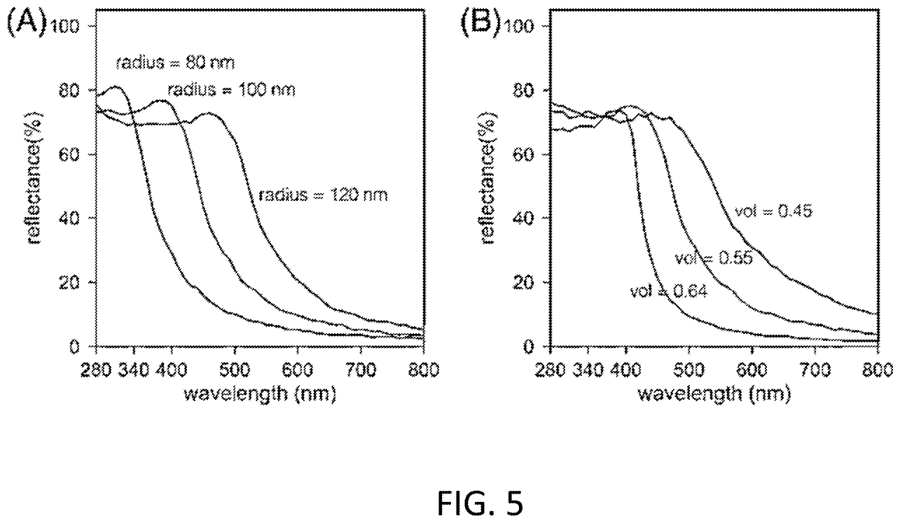

Optical properties of the inverse structures, including the nanoparticle or pore radius and volume fraction, described above can be tuned to improve reflectance. FIG. 5 view (A) shows the reflectance of a UV filtering photonic material according to certain embodiments with different air void radii (80, 100, 120 nm) with volume fraction of 64% and thickness 44 μm. With increasing air void radius, the reflectance peak shifts to longer wavelengths. Therefore, according to certain embodiments, the void size at least partially controls what wavelengths are reflected. For example, for a given volume fraction and thickness, increasing the void radius would shift the reflectance peak to longer wavelengths because increasing the void size increases the average spacing between the voids, which is a parameter in determining reflectance peak wavelength. The larger the inter-void spacing, the longer the reflectance peak wavelength. FIG. 5 view (B) shows the reflectance of a UV filtering photonic material according to certain embodiments with different air void volume fractions (0.45, 0.55, 0.64) with air void radius of 107.5 nm and thickness 44 μm. Increasing the volume fraction shifts the peak to lower wavelengths. For example, increasing the volume fraction decreases the average spacing between the voids. Shorter inter-void spacing results in a shorter wavelength reflectance peak. In addition, as shown in FIG. 5 view (B), for a higher volume fraction, the drop in reflectance from the UV to visible becomes sharper. Therefore, according to certain embodiments, the UV reflectance is increased while also increasing the visible transmittance.

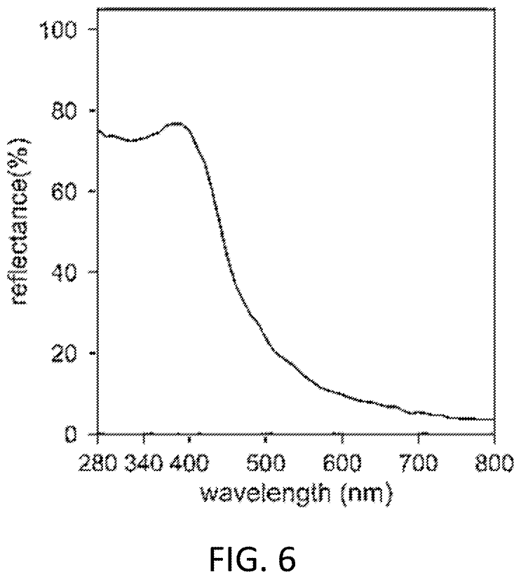

FIG. 6 shows the reflectance of a UV filtering photonic material achieving 70% reflectance across both UVA and UVB wavelength regimes (from 290-400 nm), according to certain embodiments. The UV filtering photonic material of FIG. 6 achieves this reflectance using an inverse PLA structure, air voids with volume fraction of 64% and radius of 107.5 nm, and thickness of 44 μm. In certain embodiments, lower values of the reflectances are possible at lower volume fractions (e.g., down to 0%) and lower thicknesses (down to 1 micrometer), such as described below regarding the theoretical maximum.

In certain embodiments, the inverse structure UV filtering photonic material has polydispersity in pore sizes. In certain embodiments, polydispersity is defined as pdi=σ_{R}/R̅. Here, σ_{R} is the root mean square deviation from mean radius, and R̅ is the mean radius.

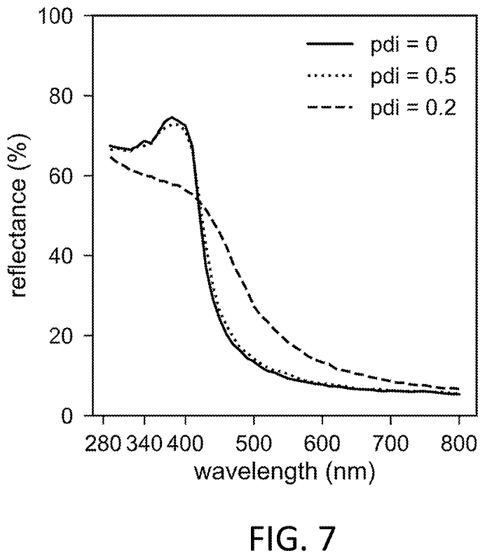

FIG. 7 shows the effect of polydispersity on the reflectance of inverse PLA structures, according to certain embodiments. The graph represents air voids with volume fraction 64% and radius 107.5 nm, and sample thickness 44 μm. As shown in FIG. 7, increased polydispersity makes the transition between UV and visible reflectance less sharp. For example, 5% polydispersity has little effect on the reflectance, whereas 20% polydispersity lowers the UV reflectance and increases visible reflectance, which is not desired. Therefore, the UV filtering properties are to some degree tolerant to polydispersity, but in certain embodiments, the polydispersity is below 20%, which helps to achieve a sharp transition from high UV reflectance to low visible reflectance.

### Inverse Structure With UV Reflectance Close to the Theoretical Maximum

As described below, use of PLA as the matrix material according to certain embodiments performs well compared to the theoretical limit of real materials. As further described below, it demonstrates the benefit of adding an absorber according to certain embodiments because the maximum reflectance from even the hypothetical best real material is only ˜93%, which is lower than the desired amount according to certain embodiments. According to certain embodiments, the Lorentz model is a good approximation of the refractive index of real materials, and specifically the multi-oscillator model described below best corresponds to solid materials.

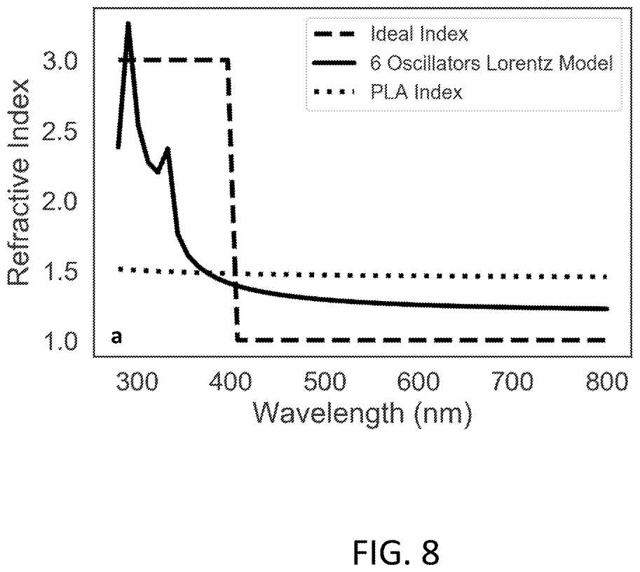

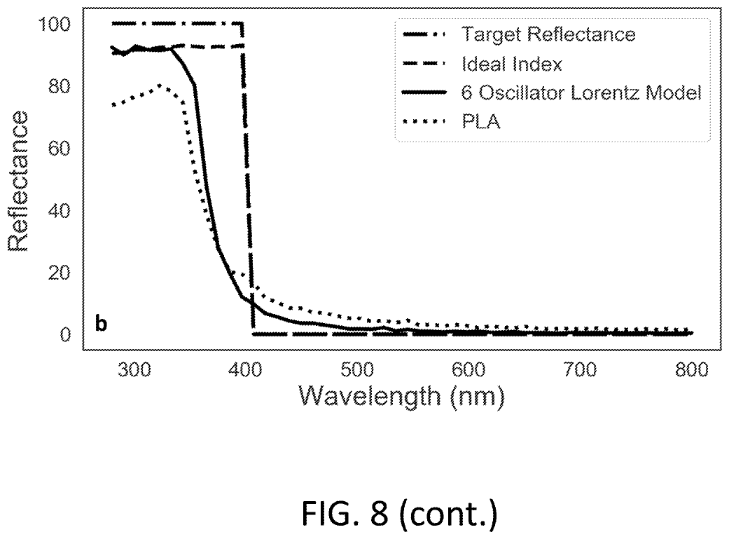

As described above, an optimal UV filtering photonic material according to certain embodiments would reflect (and/or absorb) 100% of UV light while transmitting 100% of visible light. According to certain embodiments, an optimal UV filtering photonic material can achieved using a material with a refractive index that is a step-function, with a high index in the UV and a low index in the visible, as shown in the dashed line in FIG. 8 view “a.” Differences in refractive indices cause reflection, so a low refractive index in the visible that matches or approaches that of air minimizes reflection of visible light, while a high index in the UV maximizes reflection of UV light. Minimizing reflection maximizes transmission, and maximizing reflection minimizes transmission. Therefore, a step-function index maximizes transmission in the visible while minimizing transmission in the UV. Materials according to certain embodiments approximate this behavior, as shown using a multi-oscillator Lorentz model, such as rutile titania. The model yields the dielectric functions (ε′ and ε″) of a material based on the wavelengths where it absorbs light, with each “oscillator” corresponding to an absorption line. Because the Lorentz model captures the physics of light-matter interactions, the modeled materials accurately approximate the dispersion (index of refraction as a function of wavelength) of the material.

In certain embodiments, the dielectric functions are calculated by summing the effects of each oscillator:

$${ε}^{′} = 1 + {\sum }_{j} \frac{\frac{1}{{λ}_{p j}^{2}} ( \frac{1}{{λ}_{j}^{2}} - \frac{1}{{λ}^{2}} )}{{( \frac{1}{{λ}_{j}^{2}} - \frac{1}{{λ}^{2}} )}^{2} + \frac{{γ}_{j}^{2}}{4 π {c}^{2} {λ}^{2}}} \qquad ( 4 )$$

$${ε}^{″} = {\sum }_{j} \frac{\frac{{γ}_{j}}{{λ}_{p j}^{2} λ}}{2 π c [ {( \frac{1}{{λ}_{j}^{2}} - \frac{1}{{λ}^{2}} )}^{2} + \frac{{γ}_{j}^{2}}{4 π {c}^{2} {λ}^{2}} ]} , \qquad ( 5 )$$

where λⱼ is the wavelength of the j^{th} absorption peak, λ_{pj.} is its magnitude, and yⱼ its width. The dielectric functions are related to the real part (n) and imaginary part (k) of the refractive index:

$$n = \sqrt{\frac{{ϵ}^{′} + {{ϵ}^{″}}^{2} - {ϵ}^{′}}{2}} \qquad ( 6 )$$

$$k = \sqrt{\frac{{ϵ}^{′} + {{ϵ}^{″}}^{2} - {ϵ}^{′}}{2}} \qquad ( 7 )$$

In certain embodiments, six oscillators are used to approximate an absorption band from 290 nm to 330 nm, as might be found in a solid material that absorbs light over a range of wavelengths in the UV, as described above. The resulting material has an index of refraction that increases to about 3.0 at 300 nm and decreases to 1.2 in the visible, as shown in FIG. 8 view “a.” By comparison, PLA has an index that is nearly flat across the UVA, UVB, and visible.

In certain embodiments, the calculated refractive index functions for the respective materials can be used as inputs for Monte Carlo simulations to calculate the wavelength dependent reflectance. Despite the flatness of the dispersion curve of PLA, porous materials with PLA as the matrix reflect nearly as much UV radiation as porous materials made from the ideal material modeled by the 6 Oscillator Lorentz Model. Photonic structures made from both PLA and the ideal material modeled by the 6 Oscillator Lorentz Model material have a sharp transition from high reflectance in the UV to low reflectance in the visible, as shown in FIG. 8 view “b.” The UV reflectance of the ideal material modeled by the 6 Oscillator Lorentz Model material is 10-15% higher than that of the porous PLA nanostructure.

A nanoporous structure made from a material with a step function dispersion curve has nearly the same reflectance in the UVB region and in the visible as that made from the Lorentz hypothetical material, but it performs better in the UVA. Overall, these results indicate that the performance of PLA is near to the ideal. In certain embodiments, other polymers with similar refractive index to PLA would have similar performance to PLA.

FIG. 8 view “a” shows a graphical representation of the refractive index of the material modeled by a 6-oscillator Lorentz model, described above, compared to reported values of the refractive index of PLA and an ideal index of refraction. FIG. 8 view “b” shows a graphical representation of the calculated reflectance from nanoporous materials with a matrix phase of PLA, the Lorentz modeled material, and an ideal step-function index shown in view “a.” The parameters for the materials in FIG. 8 are air void volume fraction 64%, air void radius 90.0 nm, and sample thickness 50 μm.

### Absorber Further Improves UV Blocking Efficiency

As described above, photonic sunscreens made from biodegradable PLA inverse structures without absorption can achieve high UV reflectance (70%). Adding absorption enhances UV filtering performance. The effects of adding absorbers to the PLA matrix can be calculated, such as adding melanin, ZnO, and TiO₂ (rutile), as in certain embodiments. Melanin is a biological and biocompatible pigment, and ZnO, and TiO₂ are already approved to be used in sunscreens.

In certain embodiments, TiO₂ can be added in amounts less than 25% v/v, less than 7%, less than 5%, less than 3%, less than 1%, or less than 0.6%. In certain embodiments, ZnO can be added in amounts less than 10%, less than 7%, less than 5%, less than 3%, less than 1%, or less than 0.6%. In certain embodiments, melanin can be added in amounts less than 7%, less than 5%, less than 3%, less than 1%, or less than 0.6%.

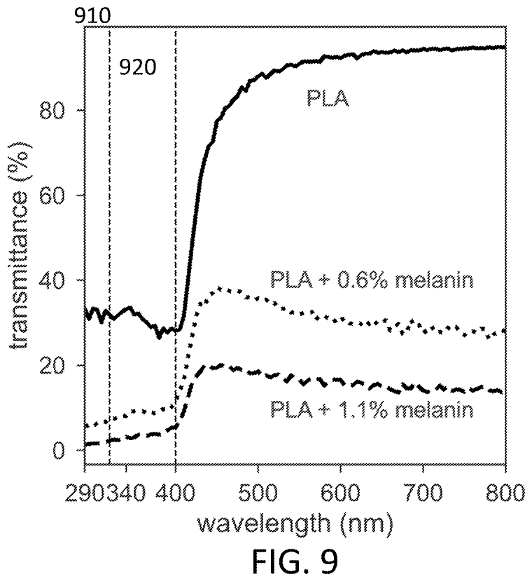

FIG. 9 shows transmittance spectra of inverse PLA structures doped with varying amounts of melanin (0%, 0.6%, 1.1% v/v with respect to the matrix). The region 910 is UVB and the region 920 is UVA. The parameters used in FIG. 9 are air-void volume fraction 64%, air void radius 107.5 nm, and sample thickness about 44 μm. As shown in FIG. 9, adding a small amount (about 1% v/v) of melanin to the matrix, according to certain embodiments, dramatically decreases UVB and UVA transmittance to less than 10%, but it also reduces the visible transmittance to below 40%. Such a pigment would therefore alter the appearance of the skin. In certain embodiments, desired transmittance is above 80% in the visible range to appear transparent.

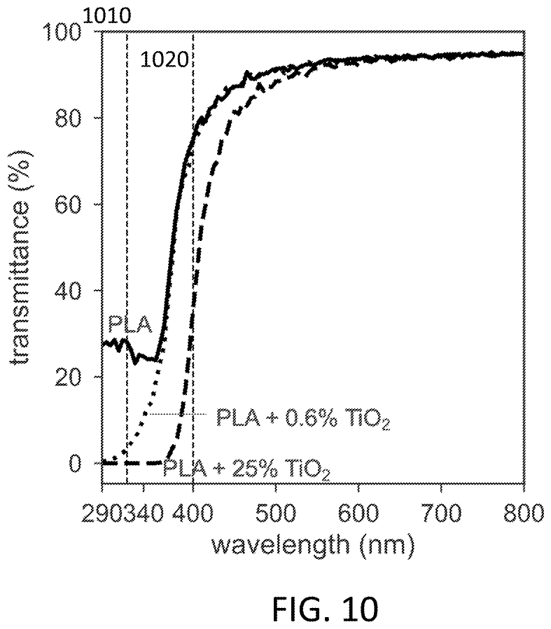

FIG. 10 shows transmittance spectra of inverse PLA structures doped with varying amounts of TiO₂ (0%, 0.6%, 25% v/v with respect to the matrix). The region 1010 is UVB and the region 1020 is UVA. The parameters used in FIG. 10 are air-void volume fraction 64%, air void radius 95 nm, and sample thickness 29-44 μm depending on the volume fraction of TiO₂ (e.g., thicknesses of 44.1, 43.6, and 29.3 um for 0%, 0.6%, 25% v/v TiO₂, respectively). As shown in FIG. 10, adding TiO₂ to the matrix according to certain embodiments instead of melanin improves UV blocking without sacrificing visible transparency. Adding 0.6% v/v TiO₂ reduces UVB transmittance to less than 10%, while the visible transmittance remains high. UVA is not blocked to the same extent as with melanin (<10% transmittance at all wavelengths within UVA) even at 25% v/v TiO₂. The absence of effective UVA blocking is due to the absorption of TiO₂ being negligible in the long UVA regime.

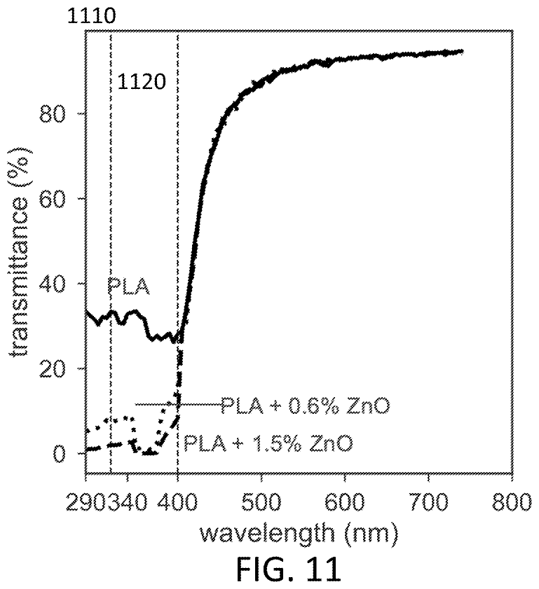

FIG. 11 shows transmittance spectra of inverse PLA structures doped with varying amounts of ZnO (0%, 0.6%, 1.5% v/v with respect to the matrix). The region 1110 is UVB and the region 1120 is UVA. The parameters used in FIG. 11 are air-void volume fraction 64%, air void radius 107.5 nm, and sample thickness 42-44 μm depending on the volume fraction of ZnO (e.g., thicknesses of 44.1, 43.2, and 41.9 μm for 0%, 0.6%, 1.5% v/v ZnO, respectively). The complex refractive index of ZnO we use here is combined from two sources, so that the dispersion can be modeled across the full UV and visible range. For wavelengths below 350 nm, we use data from Stelling et al. (Plasmonic Nanomeshes: Their Ambivalent Role as Transparent Electrodes in Organic Solar Cells. Sci. Rep. 2017, 7 (1), 42530); and for wavelengths above 350 nm, we use data from Srikant and Clarke (On the Optical Band Gap of Zinc Oxide. J. Appl. Phys. 1998, 83 (10), 5447-5451) where there is no obvious absorption peak in the visible regions. Adding only 1.5% v/v of ZnO leads to broadband UV protection, as shown in FIG. 11. The discontinuity in the transmittance spectra comes from the discontinuity of indices when combining the two data sets. Direct measurement of the complex index of ZnO nanoparticles, however, would produce a transmittance spectra with the same result of absorption at UV wavelengths and transmission at visible wavelengths.

### Multiple Scattering From the Nanoporous Structures Enhances Absorption From Doped Nanoparticles

As described above, adding small amounts of absorber according to certain embodiments efficiently decrease the transmittance of the photonic nanostructures. This decrease results, at least in part, from multiple scattering of light traveling through the nanostructure. Namely, the multiply scattering light has more opportunities to be absorbed before it exits; thus multiple scattering enhances the absorption, according to certain embodiments. Similarly, in certain embodiments, the multiply scattering light reduces the amount of absorbing nanoparticles required to achieve a desired level of UV blocking.

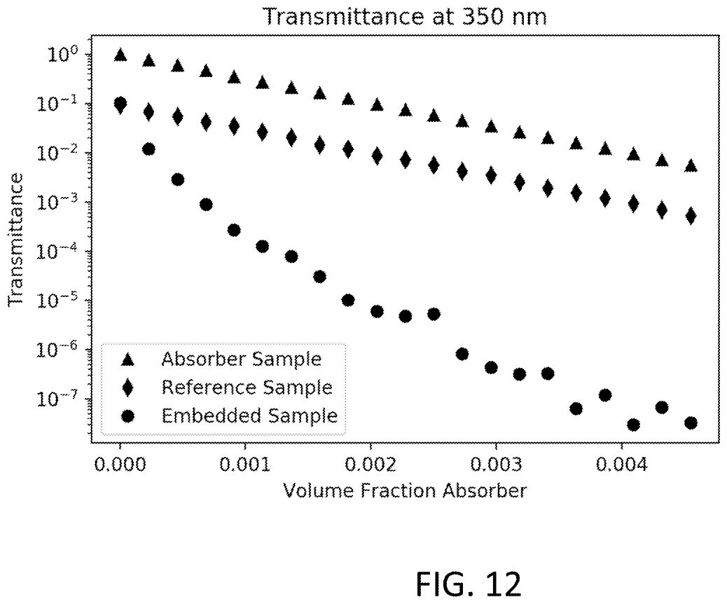

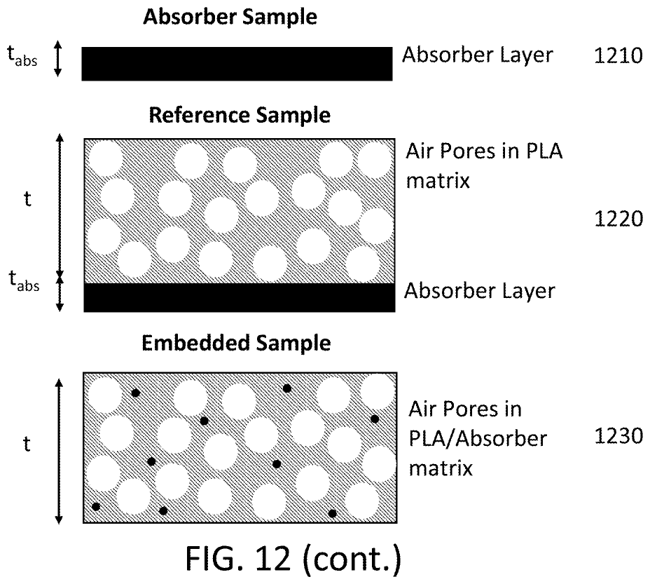

This effect is demonstrated by examining two different mechanisms of incorporating absorption: one in which the absorbing material is layered under the nanostructure, and one in which the absorber is embedded throughout the matrix of the nanostructure. FIG. 12 depicts schematics of alternate mechanisms of incorporating absorption, along with the transmittance as a function of volume fraction of the absorber. In particular, 1210 is an illustration of an absorber layer (“absorber sample”), 1220 is an illustration of an absorbing material is layered under the nanostructure (“reference sample”), and 1230 is an illustration of an absorber that is embedded throughout the matrix of the nanostructure (“embedded sample”). In certain embodiments, the absorber is placed in the voids. For example, immersing the porous material in a solution of absorbing material and then evaporating the solvent can result in the absorber coating the walls of the pores. In certain embodiments and for illustrative purposes, the amount of absorber is the same in the reference sample 1220 and the embedded sample 1230 by relating the thickness of the absorbing layer (t_{abs}) to the thickness of the nanostructure (t), the volume fraction of the matrix (Φₘₐₜᵣᵢₓ) and the volume fraction of absorber within the matrix (Φ_{absorber}):

$${t}_{a b s} = t {Φ}_{matrix} {Φ}_{absorber} \qquad ( 8 )$$

Monte Carlo simulations (with parameters: scattering layer thickness: 200 μm, pore diameter: 215 nm, pore volume fraction: 0.64, imaginary index of absorber 0.44) show that the transmittance is lower when the absorber is embedded in the nanostructure rather than concentrated in a layer underneath, as shown on the left side of FIG. 12 where the transmittance values are plotted at a single wavelength (350 nm), which is used for illustrative purposes. An illustrative wavelength is shown in FIG. 12, but the trend shown would be true across wavelengths and parameters that lead to multiple scattering, according to certain embodiments described herein. When plotted on a log (transmittance) scale as shown on the left side of FIG. 12, the transmittance of the layered samples 1210 and 1220 according to certain embodiments is linear with absorber concentration, following the relationship we expect based on Beer's law—and indeed, this linear scaling is identical to that of a purely absorbing sample with thickness t_{abs}, though the layered structure has a lower transmittance due to the scattering.

The embedded sample of certain embodiments shows a larger and nonlinear (on the same semilog plot) reduction in transmittance, showing that scattering within the nanostructure increases the absorption. At absorber concentration of 0.1% v/v or higher, embedding the absorber reduces the transmittance by orders of magnitude compared to the layered system 1210 and 1220. Accordingly, scattering leads to more interactions between light and the absorbing material of certain embodiments, resulting in an enhanced blocking of light relative to non-scattering formulations.

Doping a PLA matrix with small amounts of TiO2 or ZnO, according to certain embodiments, uses the interaction of the scattered light and the absorber to reduce the total amount of TiO₂ or ZnO needed from approximately 10-15% w/w in current sunscreens to achieve an SPF of 50-60 to less than 2% w/w TiO₂ (see, e.g., FIG. 10) in a photonic sunscreen with SPF 118 (Table 1) or less than 7% w/w ZnO (see, e.g., FIG. 11) for SPF 88 (Table 1). Calculation of the SPF values for the sunscreens according to certain embodiments is discussed below. As described below, embedding the absorber in the photonic material (as opposed to just using the absorber) reduces the amount of absorber required to reach a particular SPF value.

### Degree of Order in the Nanostructure

In embodiments discussed above, the pores or nanoparticles in the photonic nanostructure have liquid-like short-range order. An example of such a configuration is if the pores or nanoparticles are packed densely but not overlapping. The degree of order can be quantified using the structure factor, which is a function of volume fraction.

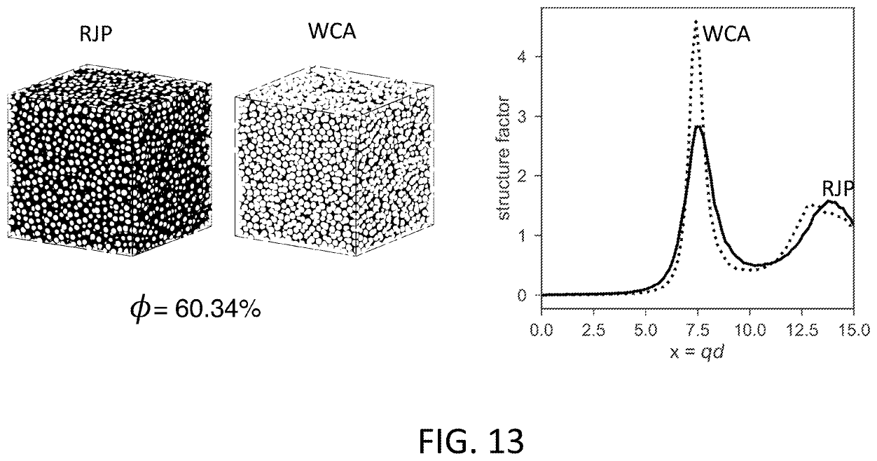

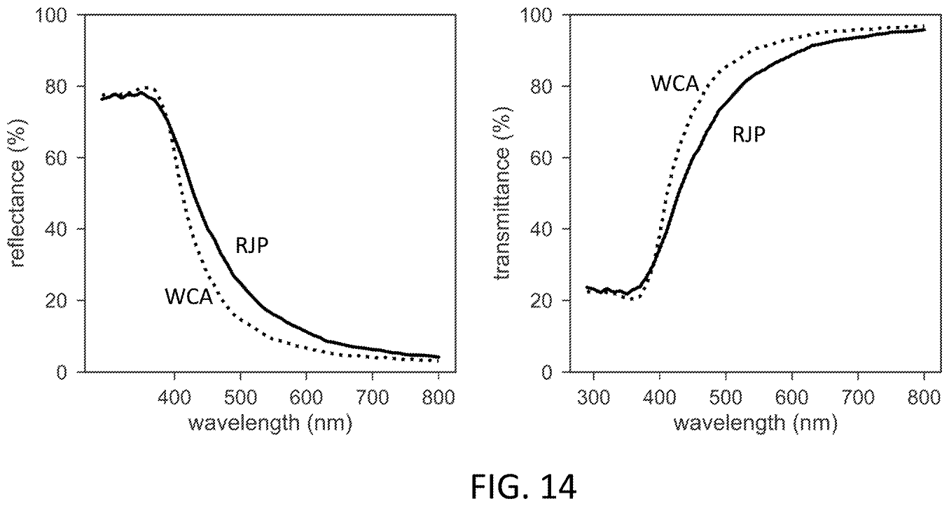

Comparing two types of packings with the same volume fraction but different structure factors shows how the structure factor of pore packing affects the UV filtering efficiency, according to certain embodiments. One type of structure is called a random jammed packing (RJP, as shown on the left side of FIG. 13), and it represents hard spheres that are touching one another. Another is a packing of particles that interact through a modified Weeks-Chandler-Anderson potential (WCA, as shown on the left side of FIG. 13), representing softer particles. Although both have the same volume fraction (Φ=0.6034), the structure factor of the WCA packing has a sharper first peak than that of the RJP packing, indicating a higher degree of short-range order, as shown on the right side of FIG. 13. This first peak is what gives rise to the peak in the reflectance spectrum. The wavelength of the peak can be adjusted based on the particle radius. To place this reflectance peak within the UV region, we use a particle radius of 95 nm (in certain embodiments, another particle radius can be used, such as for different volume fractions). In the absence of absorption according to certain embodiments, the WCA packing reflects slightly more in the UVA region and slightly less at short visible wavelengths compared to RJP, as illustrated in FIG. 14 (with parameters: pore diameter=190 nm, thickness=50 μm, particle index=1, matrix index=1.5, and Φ=0.6034). Thus, according to certain embodiments, the WCA packing performs better in both the UV and visible.

In certain embodiments, different methods of making the nanostructure can be used to result in different types of short-range order. For some methods, the nanostructure might resemble RJP, for others WCA, and others can have a structure factor that is different from both. For example, others can have a more ordered structure and a sharper structure factor peak, which leads to a sharper cutoff between the UV and visible transmittance spectra. According to certain embodiments, the details of the packing in the nanostructure affects both the UV filtering and the visible transparency. Thus the ideal fabrication method according to certain embodiments would yield nanostructures with a high degree of short-range order (as described above). As shown in FIG. 13, the first peak of the structure factor determines the location of the reflectance peak in the UV, and the height of this peak quantifies the short-range order. In general, the first peak of the structure factor has a wavevector q=2π/d, where d is the average distance between pores/nanoparticles, which is approximately their diameter. To set the peak of the reflectance spectra to a particular wavelength (for example in the UV), according to certain embodiments, the structure factor is first calculated for the given packing, then the diameter of the nanoparticles or pores is chosen such that λ=2dn_{eff}, where n_{eff} is the effective medium index, determined by the indices of refraction of the matrix material and nanoparticles or pores, and the volume fraction of the nanoparticles or pores (see equation 2 described above). The higher the degree of short-range order, as quantified by the height of the structure factor, the larger the reflectance at the peak wavelength. High short-range order corresponds to more UV light reflected.

In certain embodiments, the short-range order of the nanostructure has a length scale of approximately ½ the wavelength of the reflectance peak. In certain embodiments, the short-range correlations should have a length scale of λ/(2n_{eff}) or approximately λ/(2n_{eff}). In certain embodiments, the structure factor, such as shown in FIG. 13, has two peaks. In certain embodiments, the first peak has a structure factor value greater than 1. In certain embodiments, the first peak has a structure factor value greater than 1 and less than 10. In certain embodiments, the first peak is at approximately x=2πn_{eff}, where x=qd.

### Evaluation of Performance

To determine how inverse structures perform in sunscreen applications, the UV blocking efficiency is calculated based on sunscreen standards, and transparency is quantified by how much the material changes the color of skin to which it is applied.

### Quantification of UV and Visible Transmittance

The amount of UV radiation the UV filtering photonic structures of certain

embodiments can block can be calculated using standards that are used or proposed for use in sunscreen industry. These include SPF values and two different ways of rating UVA protection, as further described below.

SPF is an in vivo measurement where one compares the sunburn UV dose on skins of volunteers without and covered with sunscreens. It is defined as the ratio of the sunburn radiation dose with and without sunscreen (in practice, SPF can also be calculated using transmittance). When the in vivo measurement cannot be done, one can calculate the SPF from the transmittance (Tλ) and erythema action spectrum (Eλ), which accounts for skin damage as a function of wavelength:

$$S P F = \frac{{\int }_{290 nm}^{400 nm} E ( λ ) d λ}{{\int }_{290 nm}^{400 nm} E ( λ ) T ( λ ) d λ} \qquad ( 9 )$$

$$where E ( λ ) = \{ \begin{matrix}1.0 , & 280 nm \leq λ < 298 nm \\ 1 {0}^{0.094 ( 298 - λ )} , & 298 nm \leq λ < 328 nm \\ 1 {0}^{0.015 ( 139 - λ )} , & 328 nm \leq λ < 400 nm\end{matrix} .$$

The simulated transmittance can be used to calculate the SPF values for the porous PLA doped with different absorbers described in embodiments above. Table 1 shows the UV protection efficacy and visible transmittance for different simulated structures. Bolded entries represent better performance compared with unbolded entries. As shown in Table 1, the SPF values can be above 50 when doping 1.1% melanin, 0.6% TiO₂, or 1.5% ZnO. As shown in Table 1, 0.6-25% TiO₂ gives very high SPF, which is desirable for sunscreens according to certain embodiments. However, the TiO₂ does not give much UVA protection (which is not quantified by SPF but is desirable for preventing other types of effects of sunlight on skin according to certain embodiments). 1-1.5% ZnO yields good SPF as well as good UVA blocking. With either TiO₂ or ZnO, the visible transmittance of the photonic nanomaterial is high, which is desirable according to certain embodiments so that the material does not alter the color of the substance (such as skin) on which it is used.

| | | UVA/UVB | Critical | Visible |
|---|---|---|---|---|
| | in-vitro | (Boots star | wave- | trans- |
| sample | SPF | rating) | length (nm) | mittance |
| Pure porous PLA | 3.1 | 1.07 | 390 | 0.87 |
| +0.6% melanin | 16.8 | 0.87 (star 4) | 388 | 0.30 |
| +1.1% melanin | 64.2 | 0.83 (star 4) | 387 | 0.16 |
| +0.6% TiO2 | 118 | 0.27 (no star) | 362 | 0.92 |
| +25% TiO2 | 1916 | 0.06 (no star) | 339 | 0.89 |
| +0.6% ZnO | 18 | 0.98 (star 5) | 385 | 0.85 |
| +1.5% ZnO | 88 | 0.88 (star 4) | 383 | 0.85 |

From the erythema action spectrum we can see that a low UVB transmittance contributes much more to a high SPF value than UVA, such that high SPF values can be achieved by blocking UVB alone, according to certain embodiments. However, in certain embodiments, sunscreens should also block some amount of UVA light.

Two standards can be used to evaluate the UVA-blocking performance of our simulated sunscreens. First, another sunscreen rating system called the Boots star rating system, which is the ratio of UVA absorbance to UVB absorbance, can be used to evaluate the UVA blocking performance. There are three levels in the Boot star rating system: star 3 for a ratio greater than 0.6, star 4 for a ratio greater than 0.8, and star 5 for a ratio greater than 0.9. Doping melanin and ZnO into photonic nanostructures, according to certain embodiments, leads to high Boots star ratings (4 and 5), as shown in Table 1. The addition of TiO₂, according to certain embodiments, does not meet the requirements for Boots star rating, even at 25% v/v, as shown in Table 1. This is because TiO₂ absorbs relatively weakly in the UVA region compared to melanin and ZnO. However, TiO₂ nonetheless leads to very effective blocking of UVB and high SPF values, which are desirable for sunscreens according to certain embodiments.

The second method to evaluate UVA blocking performance is the critical wavelength, defined as the value of λ_{c} that satisfies the equation

$${\int }_{290}^{400} ( λ ) d λ = 0.9 {\int }_{290}^{400} A ( λ ) d λ , \qquad ( 10 )$$

where A(λ) is absorbance. Higher critical wavelengths indicate more protection from UVA, with a critical wavelength above 370 nm considered effective broadband UV protection, according to certain embodiments. As shown in Table 1, the materials that have 4 or 5 Boots stars have a critical wavelength above 370 nm while the TiO₂ doped materials do not.

In certain embodiments, the visible transmittance can be quantified by the average transmittance from 400 to 800 nm, for example using Monte Carlo simulations. The visible transparency is high when we dope TiO₂ or ZnO but relatively lower when doped with melanin. The low transparency with melanin arises because it is a broadband absorber, so the addition of melanin leads to increased absorption of both UV and visible light.

As shown in Table 1 a nanoporous PLA sample is doped with 1.5% v/v ZnO achieves both broadband UV protection and high visible transparency, and doping with 0.6-25% TiO₂ achieves high UVB protection and high SPF values with high visible transparency.

### Transparency Evaluation

To determine how the visible transmittance affects the skin appearance, in certain embodiments, the combined reflectance of a film of the PLA photonic sunscreen on skin can be modeled and used to determine the difference between this reflectance and the reflectance of the skin alone. According to certain embodiments, this calculation also determines the amount of UV light that reaches the skin after accounting for reflections at the boundary between the film and the skin.

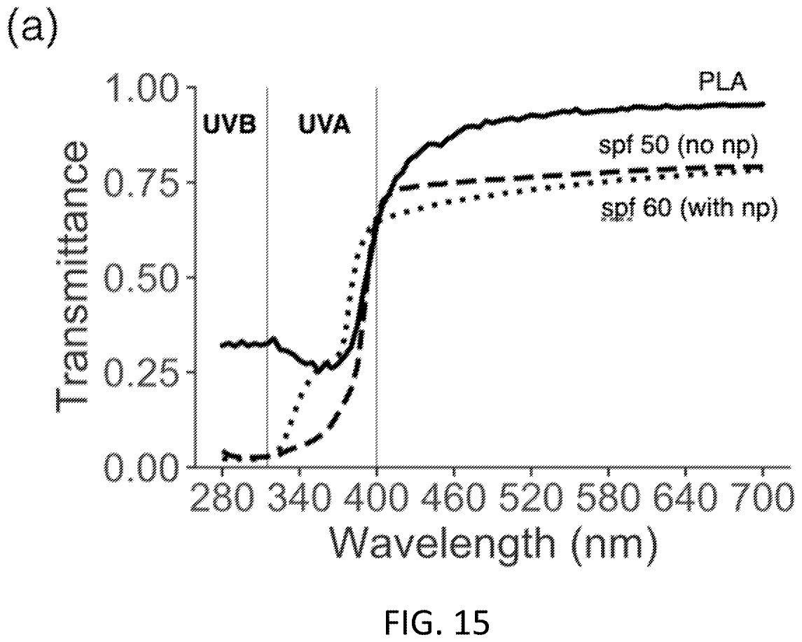

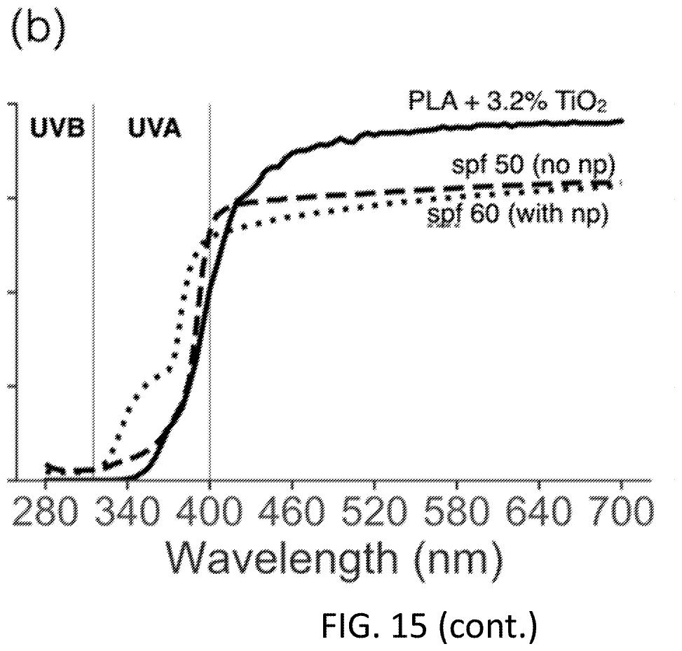

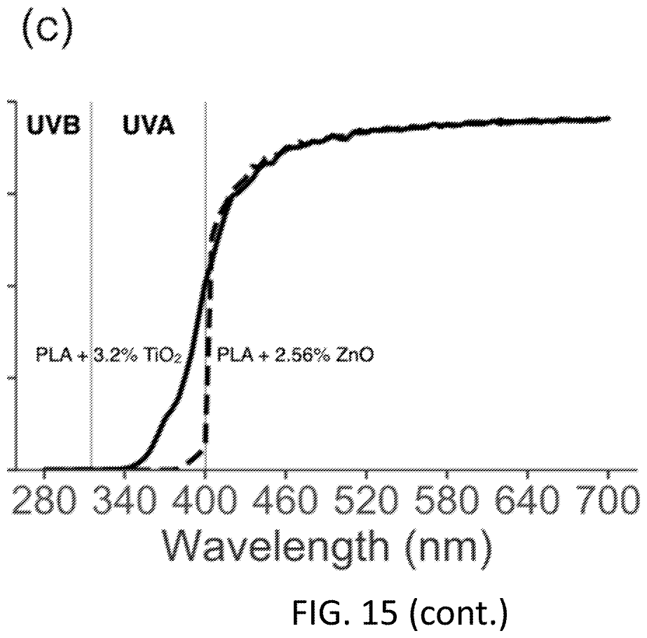

FIG. 15 compares the transmittance of UV blocking materials according to certain embodiments. FIG. 15 view (a) shows the measured transmittance spectra of two commercial sunscreens labeled “SPF 50” and “SPF 60” compared to calculated transmittance of a PLA film with 200 nm pore diameter, 44 μm thickness, and 0.64 volume fraction. FIG. 15 view (b) shows the measured transmittance spectra of two commercial sunscreens compared to calculated transmittance of a PLA film doped with titania. The film has a 200 nm pore diameter, 40 μm thickness, and 0.64 volume fraction. Film thicknesses are adjusted so that the amount applied corresponds to an application of 20 mg per square centimeter of skin, per the SPF standard. FIG. 15 view (c) shows the calculated transmittance spectra of titania and zinc oxide doped PLA films with the same film parameters as those in views (a) and (b). The calculated SPF for the spectra are also shown. Percentages shown are % v/v.

For a film composed only of nanoporous PLA, the transmittance in the UVB/UVA regimes is higher than that of commercial SPF 50 and 60 sunscreens, as shown in FIG. 15 view (a). However, doping the PLA film with a small percentage of TiO₂ or ZnO nanoparticles decreases the transmittance in the UVB and UVA significantly. The resulting materials surpass the blocking power of the commercial sunscreens shown, as shown in FIG. 15 view (b). In addition, the visible wavelength transmittance of the nanoparticle-doped PLA films is higher than that of the commercial sunscreens, indicating that the nanoporous films would alter the appearance of skin less than commercial sunscreens do.

Our calculations show that ZnO nanoparticle-doped PLA films, according to certain embodiments, provide more broadband protection than TiO₂ nanoparticle-doped PLA films, as shown in FIG. 15 view (c). The more broadband protection from ZnO doping results from the absorption spectrum of ZnO, which is peaked near 375 nm. While the analysis disclosed herein focuses on ZnO and TiO₂, the embodiments disclosed herein are not limited to those materials. Other materials, such as organic dyes, can also be used alone, or in combination with ZnO and/or TiO₂, according to certain embodiments. For example, organic dyes that absorb in the UVA and/or UVB spectrum but transmit light in the visible spectrum can be used, according to certain embodiments.

To quantitatively compare the blocking of the two nanoparticle-doped films (i.e., with ZnO and TiO₂), the SPF values are also calculated. We find an SPF of 5807 for a PLA film doped with 3.2% v/v TiO₂ nanoparticles, and SPF 1872 for a PLA film doped with 2.56% v/v ZnO nanoparticles. These SPF values far outperform available commercial sunscreens.

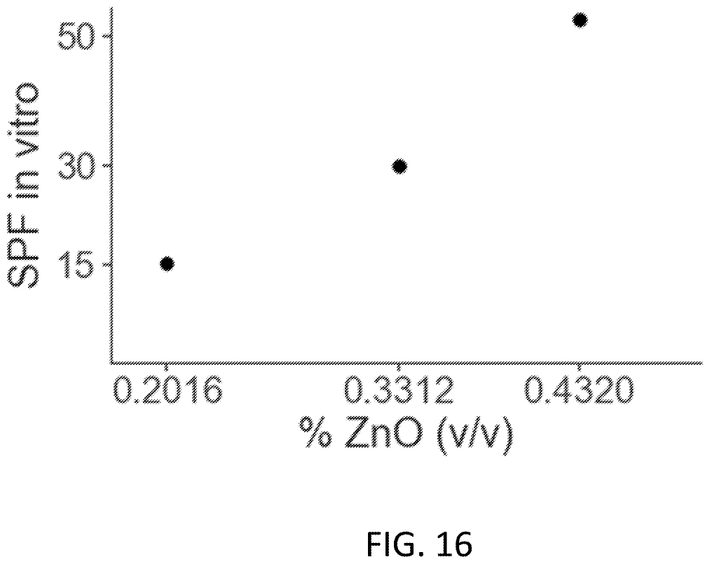

According to certain embodiments, an amount of absorber or absorbers can be added to tune the UV blocking photonic material to certain requirements. For example, the absorber can be added to achieve a desired SPF rating. As shown in FIG. 16, different amounts of ZnO can be added to achieve an SPF rating of 15, 30, and 50, according to certain embodiments. The same can be performed with TiO₂ and other absorbers, or combinations of absorbers, according to certain embodiments. The amount of absorber can also be chose to achieve other SPF values, according to certain embodiments.

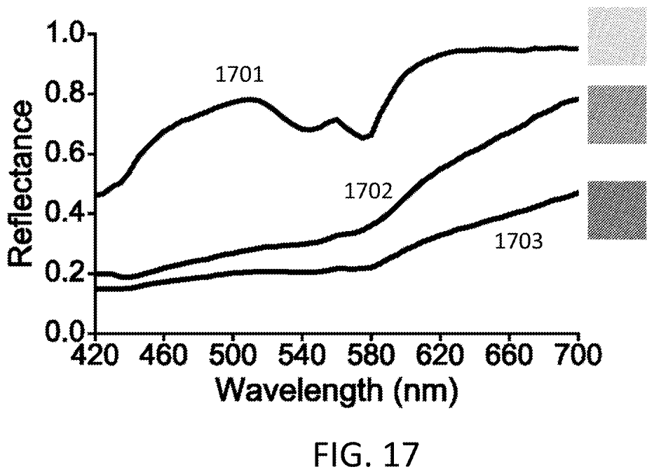

To show how the sunscreen alters the appearance of skin, we first quantify the appearance of skin alone using measured reflectance spectra of three different skin tones, as shown in FIG. 17. Corresponding color swatches for FIG. 17 generated using Colorpy software are shown to the right of each curve. The RGB and CIE LAB colors are as follows: spectrum 1701 (top): RGB color: [241 222 202], CIE LAB color: [89.35367164 3.41537351 12.00419678], spectrum 1702 (middle): RGB color: [198 150 121], CIE LAB color: [65.83408303 14.3050228 22.40620528], spectrum 1703 (bottom): RGB color: [155 126 109], CIE LAB color: [55.11550387 8.67617598 13.34002088]. A realistic rendering of the skin color can be produced based on the reflection spectrum by using the CIE 1976 color matching functions, which map the spectral response of the human eye to the CIE XYZ colorspace. We can then convert the CIE XYZ colors to the RGB colorspace for display on standard screens. Calculations can be performed using the software package ColorPy.

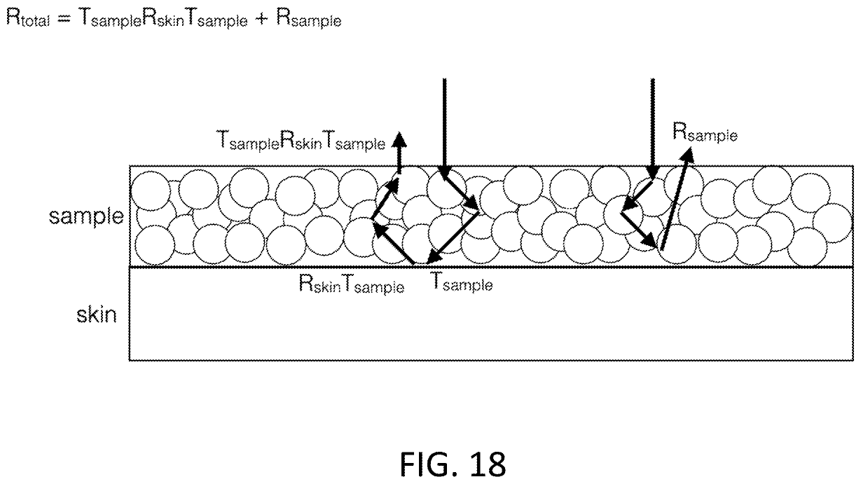

FIG. 18 is a schematic showing how the appearance of skin with a nanostructured photonic film on top is modeled. The arrows indicate light trajectories. The spheres indicate the voids in the film. R is reflectance and T is transmittance. The appearance of the UV-blocking films on a skin substrate can be modeled through a Monte Carlo simulation that accounts for the reflectance of the skin. Light transport through the nanoporous film according to disclosed embodiments is first calculated and the reflectance and transmittance is calculated. The transmittance represents the light that reaches the skin. Other light is reflected or absorbed. Multiplying the film sample transmittance by the skin reflectance and then by the sample transmittance again results in a second reflectance term. This term is added to the reflectance from the first passage of light through the film to calculate the total reflectance, as shown in FIG. 18. The resulting reflectance spectra can then be converted to a color swatch using the methods described above.

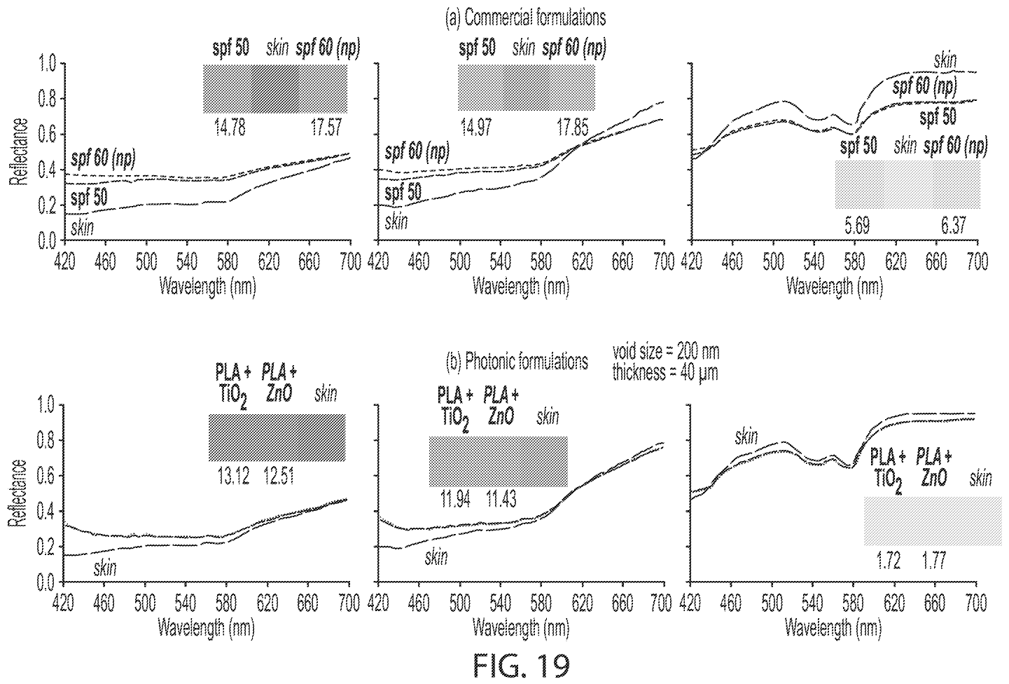

FIG. 19 view (a) shows the calculated reflectance spectra of commercial sunscreens applied to skin tones ranging from a dark (left) to a light tone (right). FIG. 19 view (b) shows calculated reflectance spectra of photonic sunscreens, according to certain embodiments, applied to the same skin tones as the commercial sunscreens. Results are shown for both nanoporous PLA+3.2% v/v titania and nanoporous PLA+2.56% v/v zinc oxide. Compared to the results shown in FIG. 19 view (b), higher amounts of these absorber, according to certain embodiments, the UV blocking would increase but the visible transparency would decrease, whereas lower amounts of these absorbers, according to certain embodiments, would increase visible transparency but decrease UV blocking. The simulated film parameters are the same as those in FIG. 15 view (B) and FIG. 15 view (C). The color values shown in each plot of FIG. 19 are summarized in Table 2, below.

TABLE 2

| Formulation | Plot | Sunscreen | RGB Color | CEI LAB Color |
|---|---|---|---|---|
| (a) | Left | Spf 50 | [170 158 152] | [65.85089442 |
| Commercial | | | | 3.23493063 |
| formulations | | | | 4.75764763] |
| | | Skin | [155 126 109] | [55.11550387 |
| | | | | 8.67617598 |
| | | | | 13.34002088] |
| | | Spf 60 (np) | [171 162 160] | [67.33505059 |
| | | | | 3.11693664 |
| | | | | 2.0080858] |
| | Middle | Spf 50 | [195 169 156] | [71.12853038 |
| | | | | 7.33156376 |
| | | | | 10.26215627] |
| | | Skin | [198 150 121] | [65.83408303 |
| | | | | 14.3050228 |
| | | | | 22.40620528] |
| | | Spf 60 (np) | [196 172 164] | [72.28327314 |
| | | | | 7.07889666 |
| | | | | 7.41475515] |
| | Right | Spf 50 | [223 210 196] | [85.00232832 |
| | | | | 2.22500919 |
| | | | | 8.53550008] |
| | | Skin | [241 222 202] | [89.35367164 |
| | | | | 3.41537351 |
| | | | | 12.00419678] |
| | | Spf 60 (np) | [222 209 197] | [84.6428192 |
| | | | | 2.41485593 |
| | | | | 7.82432118] |
| (b) | Left | PLA + TiO₂ | [159 136 140] | [58.95235468 |
| Photonic | | | | 9.04457404 |
| formulations | | | | 1.16590291] |
| | | PLA + ZnO | [159 137 141] | [59.12447528 |
| | | | | 9.1689954 |
| | | | | 0.67851057] |
| | | Skin | [155 126 109] | [55.11550387 |
| | | | | 8.67617598 |
| | | | | 13.34002088] |
| | Middle | PLA + TiO₂ | [197 155 146] | [67.66088741 |
| | | | | 13.97152396 |
| | | | | 10.91095805] |
| | | PLA + ZnO | [197 156 147] | [67.77453434 |
| | | | | 14.0305065 |
| | | | | 10.47101277] |
| | | Skin | [198 150 121] | [65.83408303 |
| | | | | 14.3050228 |
| | | | | 22.40620528] |
| | Right | PLA + TiO₂ | [236 217 200] | [87.8681195 |
| | | | | 3.79418071 |
| | | | | 11.11237649] |
| | | PLA + ZnO | [237 217 199] | [87.87707522 |
| | | | | 3.78965774 |
| | | | | 11.17182611] |
| | | Skin | [241 222 202] | [89.35367164 |
| | | | | 3.41537351 |
| | | | | 12.00419678] |

The photonic sunscreens with either TiO₂ or ZnO, according to certain embodiments, alter the skin color to a lesser extent than do commercial sunscreens, as shown in FIG. 19. The closeness of the simulated color to the original skin color for these skin tones suggests that for many applications, photonic sunscreens as disclosed herein can outperform commercially available UV-blocking films. The CIE 1976 color difference can be used to quantify how the nanoporous films and commercial sunscreens alter skin color, according to certain embodiments. This quantity is calculated by computing the total distance between the color coordinates in the XYZ colorspace and provides a single number to characterize the differences between two colors. The color differences between the skin tones and the skin covered with a nanoporous film according to certain embodiments are smaller than the color differences between the skin tones and skin covered with the commercial sunscreens, as shown in FIG. 19, demonstrating that the nanoporous films disclosed herein alter skin appearance less than the commercial sunscreens. The just noticeable difference (JND) is the minimum color difference that the average person can detect, and has been experimentally found to be 2.2. We find that for the lightest skin tone examined, the nanoporous films disclosed herein result in a color difference less than the JND. Though the nanoporous films on the two darker skin produce a color difference larger than the JND, they still show an improvement over the commercial sunscreens. In our calculations, both the visible transparency and UVA/UVB blocking of the nanoparticle-doped nanoporous PLA films outperform the commercial sunscreens for each of the three skin tones examined. These results show that nanoporous films as disclosed herein offer a significant improvement over currently available commercial sunscreens.

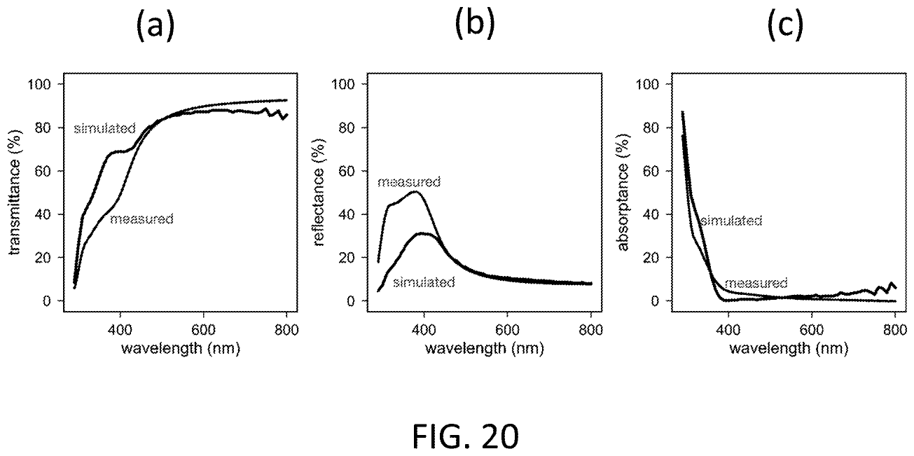

An inverse structure with low-refractive-index particles embedded in a high-index matrix is made to validate the predictions of the simulations. The inverse structure is made of silica particles (index 1.45 at 589 nm) and a matrix consisting of a copolymer of 80% poly (ethylene glycol) phenyl ether acrylate (PEGPEA) (monomer index 1.50 at 589 nm) and 20% 2-Hydroxyethyl acrylate (HEA) (monomer index 1.45 at 589 nm). Two sizes of the silica particles (80% v/v 150 nm and 20% v/v 180 nm in diameter) are mixed in ethanol with PEGPEA and 20% HEA. Evaporation of the ethanol packs the silica particles into a disordered arrangement. The mixture is injected into a glass chamber with a thickness of 100 μm. After the mixture is UV-cured and solidifies, a film is formed and peeled to be mounted on a quartz slide that has negligible absorption from 290 to 800 nm. Measurements are taken using an integrated silica sphere. Simulation is done with parameters of 50% volume fraction, 100 μm thickness and binary particles of 80% v/v 150 nm and 20% v/v 180 nm diameter. FIG. 20 view (a) and (b) show a good agreement between the simulated and measured transmittance and reflectance in the high wavelengths. FIG. 20 view (c) shows a good agreement for absorptance across all assessed wavelengths.

### Making Nanoporous Structures

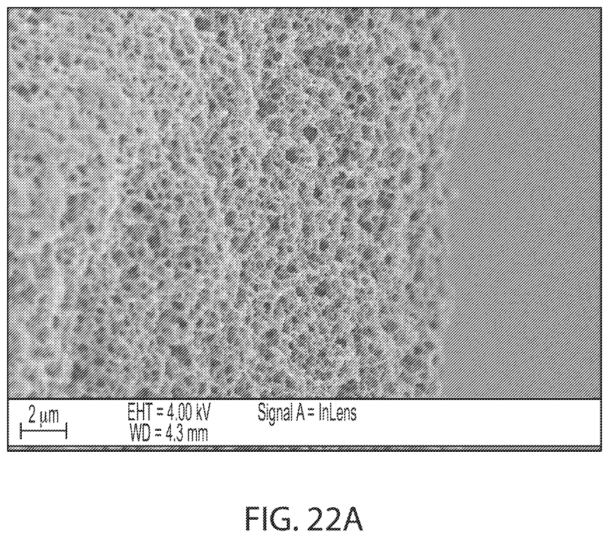

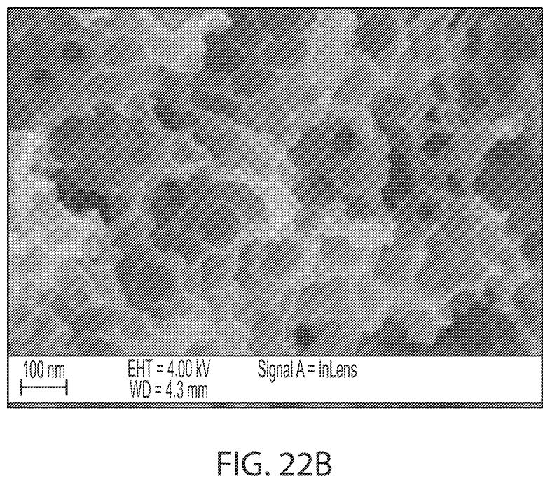

According to certain embodiments, the porous inverse photonic structures can be made using a co-assembly process in which a nanoparticle template is assembled in a polymer solution. Ta and colleagues made disordered porous structures using such a method in Flexible and Tensile Microporous Polymer Fibers for Wavelength-Tunable Random Lasing. Nanoscale 2020, 12 (23), 12357-12363, which is incorporated herein by reference. The inverse structure composed of pores in a polyvinyl alcohol (PVA) matrix can be made by starting with a PVA solution mixed with nanoscale polystyrene spheres. After the sample is dried, the polystyrene particles form a disordered packing with PVA filling the spaces between them. To dissolve the polystyrene particles, the samples are soaked in dimethyl carbonate, leaving pores in the PVA matrix. An example of a method for making a porous inverse photonic structure according to certain embodiments is described below with reference to FIGS. 22A-22B.

This process can also be used to make inverse structures, such as glasses, using PLA. In certain embodiments, the solvent used to dissolve the polystyrene and not dissolve the PLA. According to certain embodiments, the solvent can be an unsubstituted hydrocarbon, for example cyclohexane.

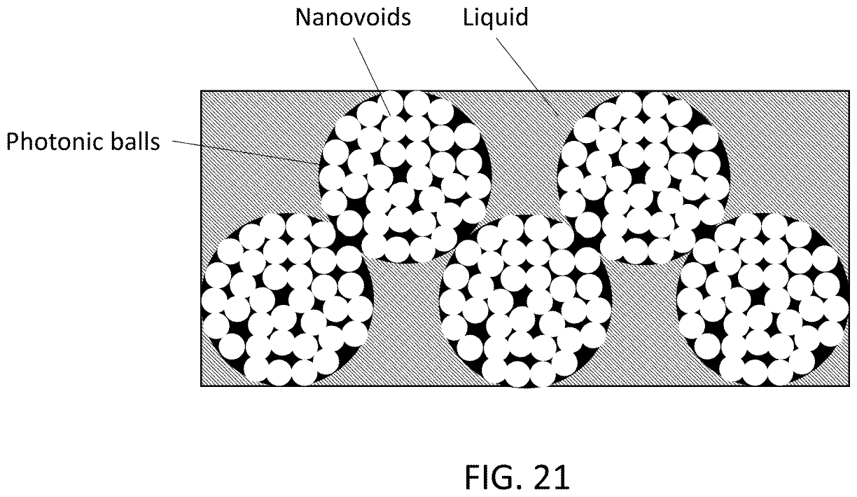

According to certain embodiments, two approaches can be used to make and formulate a sunscreen or UV protective film or coating with nanoporous structures disclosed herein. First, according to certain embodiments, “photonic balls” with air pores inside can be used, as shown in FIG. 21. These photonic balls can pack together in a matrix to form a film, which has comparable reflectance to the films disclosed here. In certain embodiments, bottlebrush polymers are used to make porous polymer photonic balls where the pores have a disordered structure. These photonic balls are tens of micrometers in diameter and could be suspended in a liquid sunscreen formulation. According to certain embodiments, the photonic balls can be between 1-100 μm in size. According to certain embodiments, the volume fraction of the pores in the photonic balls can be 30-64%. According to certain embodiments, the volume fraction of the photonic balls can be 1-64%. In certain embodiments, the photonic balls should be made or coated so that the liquid does not fill the nanopores inside. If the liquid does penetrate, the scattering will be reduced (due to a change in the relative refractive index between the matrix and the pores) and the UV-filtering capability will be lower.

The second approach, according to certain embodiments, is to make large-scale films of colloidal particles in a matrix, dissolve the particles (for example, as discussed above), and mill the films into fragments that can then be suspended in a liquid sunscreen formulation. In certain embodiments, the fragment size is 5-100 μm. This approach can be scaled up because many roll-to-roll compatible assembly methods or doctor blading can be used. Such methods can be used to make colloidal crystal films and inverse porous structures derived from them. To make disordered structures like those described in certain embodiments herein, binary particles can be used to prevent crystallization. As with certain embodiments of photonic balls, in fragment-based certain embodiments, the fragments should be designed or sealed so that liquid cannot penetrate into the pores.

Aspects and embodiments of the invention are described in the examples that follow, which are intended for the purpose of illustrating certain embodiments above only and are not intended to be limiting of the invention.

### EXAMPLE 1

### Method for Making Polymer Inverse Photonic Glasses

A 4% w/w solution of PVA (Mw 89,000-98,000) in water is mixed with a 10% w/w dispersion of polystyrene (PS) colloidal particles in water (Bangs Laboratories, 200 nm PS particles) to achieve a final dried volume fraction of PS particles equal to 0.64. This combined PVA/PS-in-water dispersion is slip cast into a solid by depositing it onto a gypsum substrate to quickly remove the water from the sample and prevent crystallization. The solid is removed from the gypsum once it is dried to obtain a direct photonic glass consisting of a PVA matrix surrounding PS particles. To remove the PS particles, the direct photonic glass is submerged in dimethyl carbonate for 24 hours. Dimethyl carbonate is a selective solvent for this system, dissolving the PS but not the PVA. After 24 hours, the excess solvent is removed, and the resulting structure is dried for 15 hours. The resulting structure is an inverse photonic glass consisting of a PVA matrix with air pores shown in FIGS. 22A-22B. FIG. 22A shows an image taken by a scanning electron microscope (SEM) of the photonic glass at 2 micrometer scale, with electron high tension (EHT) voltage of 4.00 kV and working distance (WD) of 4.3 mm. FIG. 22B shows an image taken by a scanning electron microscope (SEM) of the inverse photonic glass at 100 nm scale, with EHT voltage of 4.00 kV and WD of 4.3 mm

### EXAMPLE 2

### Method for Making Silica Inverse Photonic Glasses

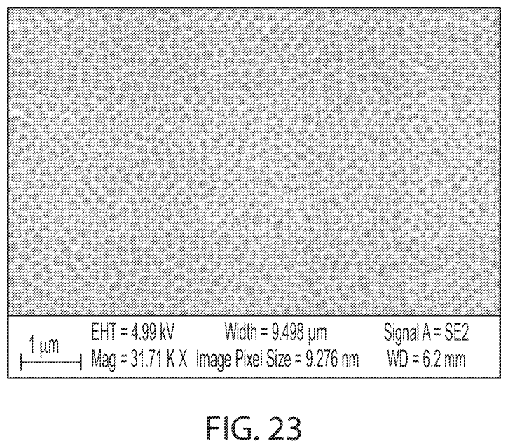

Tetraethyl orthosilicate (TEOS) is hydrolyzed by mixing equal amount of 0.1 M HCl, ethanol, and TEOS for 1 hour while being capped. After the hour, the partially hydrolyzed TEOS is mixed with the colloidal solution in a ratio of 0.5:1 (TEOS solution to colloidal solution). The colloidal solution is 10% by volume PS particles. It is either monodisperse or nearly monodisperse to display the characteristic structure. For example, the structure in FIG. 23 was produced using a mixture of two solutions: 97.5% is a solution of 300 nm PS particles (Bangs Laboratories) and 2.5% is a solution of 200 nm PS particles (Bangs Laboratories). The final mixture is deposited onto a glass slide heated to 100° C. The slide is removed from the heat as soon as the mixture is solid, which results in a direct photonic glass of silica nanocrysals surrounding PS particles. To densify the nanocrystalline matrix and remove the colloidal template, the solid mixture is calcinated by first heating it from room temperature to 500° C. over 5 hours, holding the temperature at 500° C. for 2 hours, and then allowing the mixture to cool for 8 hours. The resulting structure is an inverse photonic glasses consisting of a fused silica matrix surrounding air pores shown in FIG. 23. FIG. 23 shows an SEM image of the inverse photonic glass at 1 micrometer scale, with EHT voltage of 4.99 kV, WD of 6.2 mm, magnification (Mag) of 31.71 K X.

### Conclusions

As described herein, films consisting of a disordered arrangements of pores in a polymer matrix can effectively block UV light while maintaining high visible transparency. These materials work by multiply scattering UV light. Specific examples disclosed herein use PLA as the matrix, but other materials that do not absorb visible light much could be used, for example, polyurethane, cellulose, and silk fibroin. In addition, other polymers, liquids, and oxides that have similar real indices of refraction to PLA can be used. Without any absorption, a nanoporous PLA film (e.g., 44-μm-thick) according to certain embodiments can block 70% of incoming UVB light. High visible transparency can be simultaneously maintained by optimizing the structure so that the volume fraction of air pores is high (up to 64%), the pores are monodisperse, and their size is, for example, around 215 nm in diameter.

There are three major advantages of using structures disclosed in certain embodiments in sunscreens compared to conventional UV pigments. First, because scattering and not absorption is the primary mechanism of UV blocking, one can choose from a variety of materials (including biodegradable ones) to make those structures. Second, the multiple scattering in these materials enhances absorption, which reduces the amount of absorbing pigments or nanoparticles that are needed to achieve a desired SPF rating or UVA protection. Third, structures disclosed herein have high transmission in the visible, which result in less change to the skin appearance than traditional sunscreens with the same or lower SPF rating.

Upon review of the description and embodiments provided herein, those skilled in the art will understand that modifications and equivalent substitutions may be performed in carrying out the invention without departing from the essence of the invention. Thus, the invention is not meant to be limited by the embodiments described explicitly above.

1. A photonic material for reducing transmission of ultraviolet light, comprising:
spherical scatterers in a matrix material, the spherical scatterers having an amorphous arrangement in the matrix material, the spherical scatterers being configured to scatter ultraviolet light traveling in the matrix material, the amorphous arrangement causing multiple scattering of the ultraviolet light; and
an absorbing material disposed within one of the matrix material or the spherical scatterers, the absorbing material configured to absorb the ultraviolet light traveling in the matrix material.

2. The photonic material of claim 1, wherein a refractive index of the spherical scatterers is lower than a refractive index of the matrix material, or varies as a function of wavelength of light.

3. The photonic material of claim 2, wherein a refractive index of the spherical scatterers is lower than the refractive index of the matrix material by a difference of 0.2 to 2.7, or higher for UV light than for visible light.

4-5. (canceled)

6. The photonic material of claim 1, wherein the spherical scatterers comprise air voids in the matrix material, or nanoparticles embedded in the matrix material.

7. (canceled)

8. The photonic material of claim 1, wherein the spherical scatterers have a diameter of 100-300 nm.

9. The photonic material of claim 1, wherein the positions of the spherical scatterers have short-range correlation.

10. The photonic material of claim 1, further comprising a first structure factor peak corresponding to the short-range correlation of spherical scatter position.

11. (canceled)

12. The photonic material of claim 1, wherein the matrix material comprises one or more of a biodegradable material, a polylactide, a poly(vinylalcohol) (PVA), silica, a polymer, a liquid, or an oxide.

13-15. (canceled)

16. The photonic material of claim 1, wherein the matrix material forms a film.

17-18. (canceled)

19. The photonic material of claim 1, wherein the photonic material comprises one or more of a polyurethane, cellulose, silk fibroin, or titania.

20. The photonic material of claim 1, wherein the absorbing material comprises one or more of Zn0, Ti02, or melanin.

21-23. (canceled)

24. An ultraviolet light protective coating comprising the photonic material of claim 1.

25. The ultraviolet light protective coating of claim 24, wherein the coating comprises a sunscreen.

26. (canceled)

27. The ultraviolet light protective coating of claim 24, wherein a thickness of the coating is 5-100 μm.

28. The ultraviolet light protective coating of claim 24, wherein the photonic material comprises photonic balls dispersed within a liquid.

29. (canceled)

30. The ultraviolet light protective coating of claim 24, wherein the matrix material forms fragments dispersed within a liquid.

31. (canceled)

32. The ultraviolet light protective coating of claim 24, wherein the photonic material is coated such that the liquid does not fill the spherical scatterers within the matrix.

33. (canceled)

34. The ultraviolet light protective coating of claim 24, wherein the photonic material forms a film.

35. The photonic material of claim 1, wherein the photonic material transmits less than 30% of ultraviolet light, or more than 80% of visible light.

36. (canceled)

37. A method of manufacturing the coating of claim 24 comprising:
forming a film of spherical scatterers in the matrix material, the spherical scatterers comprising air voids in the matrix material; and
milling the film into fragments.

38-42. (canceled)
